(19) United States
(12) Patent Application Publication
(10) Pub. No.: US 2023/0347897 A1
(43) Pub. Date: Nov. 2, 2023

(54) CONTROLLER AND CONTROL METHOD FOR VEHICLE

(71) Applicant: TOYOTA JIDOSHA KABUSHIKI KAISHA, Aichi-ken (JP)

(72) Inventors: Yoshihisa UMEMURA, Nagoya-shi (JP); Suguru KUMAZAWA, Nisshin-shi (JP); Yasutaka TSUCHIDA, Toyota-shi (JP)

(21) Appl. No.: 18/307,006

(22) Filed: Apr. 26, 2023

(30) Foreign Application Priority Data
Apr. 28, 2022 (JP) 2022-074564

(51) Int. Cl. B60W 10/18; B60W 10/06; B60W 30/18

(52) U.S. Cl. CPC B60W 30/18127; B60W 10/06; B60W 10/18; B60W 2710/18

(57) ABSTRACT

A controller for a vehicle is configured to control a vehicle that includes a power unit coupled to wheels. The power unit includes an engine configured to generate force by combustion of a fuel, and a regenerative braking device configured to generate electricity by force transmitted from the wheels. The controller is configured to execute a deceleration assist control that increases a braking torque generated by the power unit during a deceleration of the vehicle when the vehicle is predicted to decelerate, compared to when the vehicle is not predicted to decelerate. The control is also configured to execute a braking torque increase prohibition process that prohibits an increase in the braking torque in the deceleration assist control when a fuel cutoff process of the engine is prohibited.

### BACKGROUND

### 1. Field

The present disclosure relates to a controller and a control method for a vehicle.

### 2. Description of Related Art

A vehicle controller disclosed in Japanese Laid-Open Patent Publication No. 2019-105184 is known as a device that controls a vehicle having a regenerative braking device that generates electricity by force transmitted from wheels. An engine of a vehicle controlled by the vehicle controller includes a filter device that traps particulate matter (PM) in exhaust gas. In such an engine, when a fuel cutoff process is performed in a state in which a large amount of PM is trapped in the filter device, the temperature of the filter may excessively rise due to heat generated by combustion of the PM. In this regard, the vehicle controller of the above publication prohibits the fuel cutoff process of the engine when the PM trapped amount of the filter device exceeds a certain value. When the fuel cutoff process is prohibited during deceleration of the vehicle, the effect of engine braking becomes weak, so that the deceleration of the vehicle decreases. Therefore, when the fuel cutoff process is prohibited, the vehicle controller of the above-mentioned publication increases the regeneration amount of the regenerative braking device during deceleration of the vehicle, thereby suppressing a decrease in the deceleration of the vehicle.

Japanese Laid-Open Patent Publication No. 2017-028749 discloses a vehicle controller that performs predictive deceleration assist control. In the predictive deceleration assist control, the vehicle controller predicts whether or not the vehicle will decelerate based on the location information of the vehicle. When the deceleration of the vehicle is predicted, the vehicle controller increases the regeneration amount of the regenerative braking device during deceleration of the vehicle as compared to when deceleration is not predicted.

The predictive deceleration assist control described in the second publication may be performed in the vehicle controller described in the first publication. In this case, it is necessary to appropriately adjust the amount of regeneration so that the controls described in the two publications are harmonized with each other.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, a controller for a vehicle is provided. The vehicle includes a power unit coupled to wheels. The power unit includes an engine configured to generate force by combustion of a fuel, and a regenerative braking device configured to generate electricity by force transmitted from the wheels. The controller includes processing circuitry. The processing circuitry is configured to execute a deceleration assist control that increases a braking torque generated by the power unit during a deceleration of the vehicle when the vehicle is predicted to decelerate, compared to when the vehicle is not predicted to decelerate. The processing circuitry is also configured to execute a braking torque increase prohibition process that prohibits an increase in the braking torque in the deceleration assist control when a fuel cutoff process of the engine is prohibited.

In another general aspect, a control method for a vehicle is provided. The vehicle includes a power unit coupled to wheels. The power unit includes an engine configured to generate force by combustion of a fuel, and a regenerative braking device configured to generate electricity by force transmitted from the wheels. The method includes: predicting whether the vehicle will decelerate; executing a deceleration assist control that increases a braking torque generated by the power unit during a deceleration of the vehicle when the vehicle is predicted to decelerate, compared to when the vehicle is not predicted to decelerate; determining whether to prohibit a fuel cutoff process of the engine; and when the fuel cutoff process is prohibited, prohibiting an increase in the braking torque in the deceleration assist control.

Other features and aspects will be apparent from the following detailed description, the drawings, and the claims.

### BRIEF DESCRIPTION OF THE DRAWINGS

FIG. 1 is a diagram schematically illustrating a configuration of a drive system of a vehicle to be controlled by a controller according to an embodiment.

FIG. 2 is a diagram schematically showing a configuration of the controller according to the embodiment.

FIG. 3 is a flowchart of a deceleration assist control routine executed by the controller of FIG. 2.

FIG. 4 is a flowchart of a drive torque control routine executed by the controller of FIG. 2.

FIG. 5 is a graph showing a relationship among a driver-requested torque set by the controller of FIG. 2, a vehicle speed, and an accelerator pedal depression amount.

FIG. 6 is a flowchart of a gradual change process routine executed by the controller of FIG. 2.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, except for operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

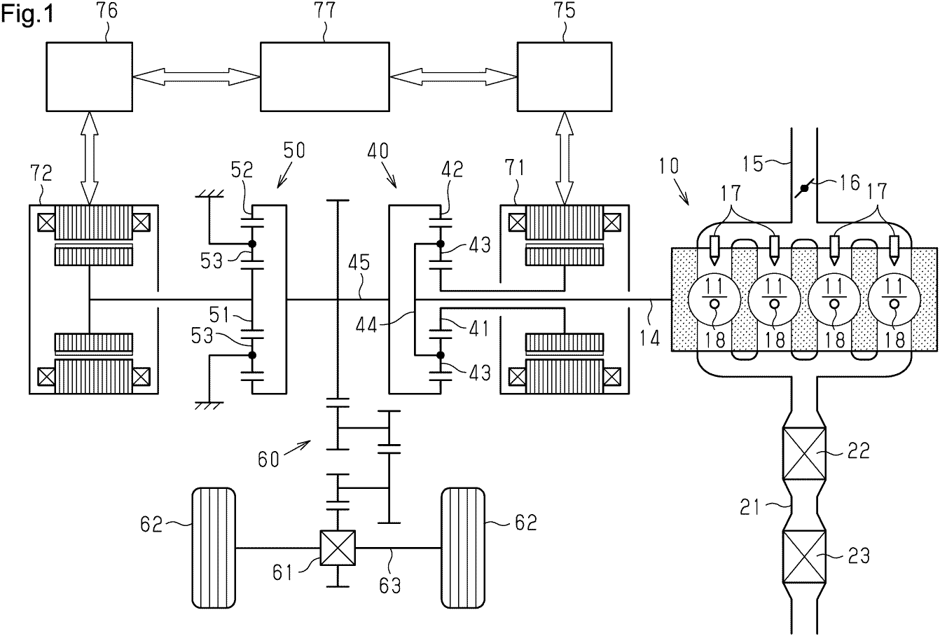

Hereinafter, an embodiment of the present disclosure will be described in detail with reference to FIGS. 1 to 6.

### Configuration of Drive System of Vehicle

Referring to FIG. 1, a configuration of a drive system of a vehicle will be described. The vehicle is a hybrid electric vehicle including a power unit that includes an engine 10, a first motor generator 71, and a second motor generator 72. The engine 10 is an internal combustion engine that generates force by combustion of fuel. Each of the first motor generator 71 and the second motor generator 72 is a generator motor having both a function as an electric motor that generates force when supplied with electricity and a function as a generator that generates electricity when receiving force from the outside.

The hybrid electric vehicle shown in FIG. 1 is provided with a vehicle on-board battery 77, a first inverter 75, and a second inverter 76. The vehicle on-board battery 77 stores electricity generated by the first motor generator 71 and the second motor generator 72 when the first motor generator 71 and the second motor generator 72 function as generators. Further, when the first motor generator 71 and the second motor generator 72 function as motors, the vehicle on-board battery 77 supplies the stored electricity to the first motor generator 71 and the second motor generator 72. The first inverter 75 adjusts the amount of electricity exchanged between the first motor generator 71 and the vehicle on-board battery 77, and the second inverter 76 adjusts the amount of electricity exchanged between the second motor generator 72 and the vehicle on-board battery 77.

The engine 10 has cylinders 11 for burning air-fuel mixture. The engine 10 is provided with an intake passage 15 serving as a passage for introducing air into the cylinders 11. The intake passage 15 is provided with a throttle valve 16 that is a valve for regulating the flow rate of intake air. A portion of the intake passage 15 downstream of the throttle valve 16 is branched to correspond to the respective cylinders 11. Each branch portion of the intake passage 15 is provided with a fuel injection valve 17. Each cylinder 11 is provided with an ignition device 18 that ignites the air-fuel mixture introduced into the cylinder 11 by spark discharge. The engine 10 is provided with an exhaust passage 21 serving as a discharge passage for exhaust gas generated by combustion of air-fuel mixture in the cylinders 11. A three-way catalyst device 22 for purifying exhaust gas is provided in the exhaust passage 21. A filter device 23 that traps particulate matter (PM) in the exhaust gas is provided downstream of the three-way catalyst device 22 in the exhaust passage 21.

Air-fuel mixture containing fuel injected by the fuel injection valves 17 is introduced into the respective cylinders 11 of the engine 10 through the intake passage 15. When the ignition device 18 ignites the air-fuel mixture, combustion occurs in the cylinder 11. Exhaust gas generated by the combustion at this time is discharged from the cylinder 11 to the exhaust passage 21. In the engine 10, the three-way catalyst device 22 oxidizes HC and CO and reduces NOx in the exhaust gas, and the filter device 23 traps PM in the exhaust gas to purify the exhaust gas.

The hybrid electric vehicle is provided with a first planetary gear mechanism 40. The first planetary gear mechanism 40 includes a sun gear 41 that is an external gear and a ring gear 42 that is an internal gear disposed coaxially with the sun gear 41. Pinions 43 meshing with both the sun gear 41 and the ring gear 42 are disposed between the sun gear 41 and the ring gear 42. Each pinion 43 is supported by a carrier 44 in a state in which the pinion 43 is free to rotate and orbit. The sun gear 41, the ring gear 42, and the carrier 44 are three rotating elements of the first planetary gear mechanism 40. The carrier 44 of the first planetary gear mechanism 40 is coupled to a crankshaft 14, which is an output shaft of the engine 10. The sun gear 41 is coupled to the first motor generator 71. A drive shaft 45 is connected to the ring gear 42. Wheels 62 are coupled to the drive shaft 45 via a speed reduction mechanism 60, a differential mechanism 61, and axles 63. That is, the drive shaft 45 serves as a force extracting shaft for the wheels 62. The first planetary gear mechanism 40 functions as a force split mechanism that splits the force of the engine 10 between the first motor generator 71 and the drive shaft 45.

A second motor generator 72 is coupled to the drive shaft 45 via a second planetary gear mechanism 50. The second planetary gear mechanism 50 includes a sun gear 51 that is an external gear and a ring gear 52 that is an internal gear disposed coaxially with the sun gear 51. Pinions 53 meshing with both the sun gear 51 and the ring gear 52 are disposed between the sun gear 51 and the ring gear 52. Each pinion 53 is free to rotate but not free to orbit. The drive shaft 45 is connected to the ring gear 52 of the second planetary gear mechanism 50, and the second motor generator 72 is connected to the sun gear 51. The second planetary gear mechanism 50 functions as a speed reduction mechanism that decelerates the rotation of the second motor generator 72 and transmits the decelerated rotation to the drive shaft 45. In the present embodiment, the second motor generator 72 corresponds to a regenerative braking device that generates electricity by the force transmitted from the wheels 62.

### Configuration of Controller

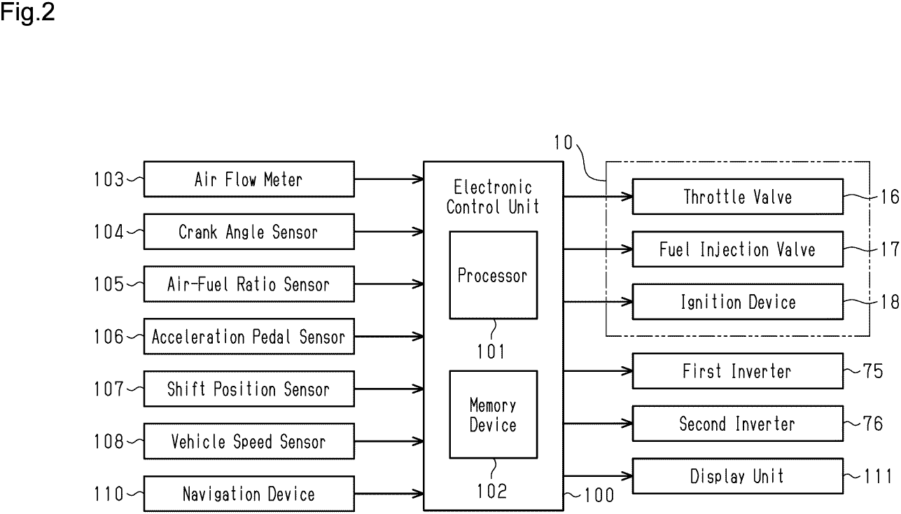

Next, the configuration of a controller according to the present embodiment will be described with reference to FIG. 2.

The hybrid electric vehicle is equipped with an electronic control unit 100 that is a controller. The electronic control unit 100 includes a processor 101 that executes various processes for vehicle control, and a memory device 102 that stores programs and data for vehicle control. In practice, the electronic control unit 100 includes multiple control units for engine control, battery control, and the like.

The hybrid electric vehicle is provided with sensors such as an air flow meter 103, a crank angle sensor 104, an air-fuel ratio sensor 105, an accelerator pedal sensor 106, a shift position sensor 107, and a vehicle speed sensor 108. The air flow meter 103 is a sensor that detects an intake air amount GA of the engine 10. The crank angle sensor 104 detects the rotational phase of the crankshaft 14. The air-fuel ratio sensor 105 is a sensor that detects the air-fuel ratio of the air-fuel mixture burned in the cylinder 11. The accelerator pedal sensor 106 is a sensor that detects an accelerator pedal depression amount ACC of the driver. The shift position sensor 107 is a sensor that detects an operation position of the shift lever by the driver. The vehicle speed sensor 108 is a sensor that detects a vehicle speed V of the hybrid electric vehicle.

Detection signals of these sensors are input to the electronic control unit 100. The electronic control unit 100 executes various controls of the hybrid electric vehicle based on the detection results of the sensors. For example, the electronic control unit 100 performs operation control of the engine 10 through control of the throttle valve 16, the fuel injection valves 17, the ignition devices 18, and the like. The electronic control unit 100 also performs torque control of the first motor generator 71 and the second motor generator 72 through control of the first inverter 75 and the second inverter 76.

The electronic control unit 100 is also connected to a navigation device 110. The navigation device 110 includes a global positioning system (GPS) sensor that detects the current position of the vehicle based on radio waves from GPS satellites. The navigation device 110 includes an acceleration sensor that detects the traveling direction of the vehicle, a memory unit that stores road information, a wireless communication device that receives road information and the like from the outside, and a display device that provides various types of information to the driver. The navigation device 110 further includes a main control unit that performs route guidance by calculating a travel route and an arrival time of the vehicle to a destination set by the driver. The road information stored in the memory unit of the navigation device 110 includes road map information, road type information, road shape information, legal speed limit information, intersection position information, and stop line position information. Further, the navigation device 110 is configured to acquire traffic signal information and traffic jam information from external communication devices installed on roads. The navigation the navigation device 110 has a function of recording travel history information such as a travelled route and a traveling speed of the vehicle in its own memory unit.

The electronic control unit 100 is also connected to a display unit 111 installed in front of the driver’s seat. The electronic control unit 100 causes the display unit 111 to display various types of information relating to the traveling state of the hybrid electric vehicle.

### Travel Control of Hybrid Electric Vehicle

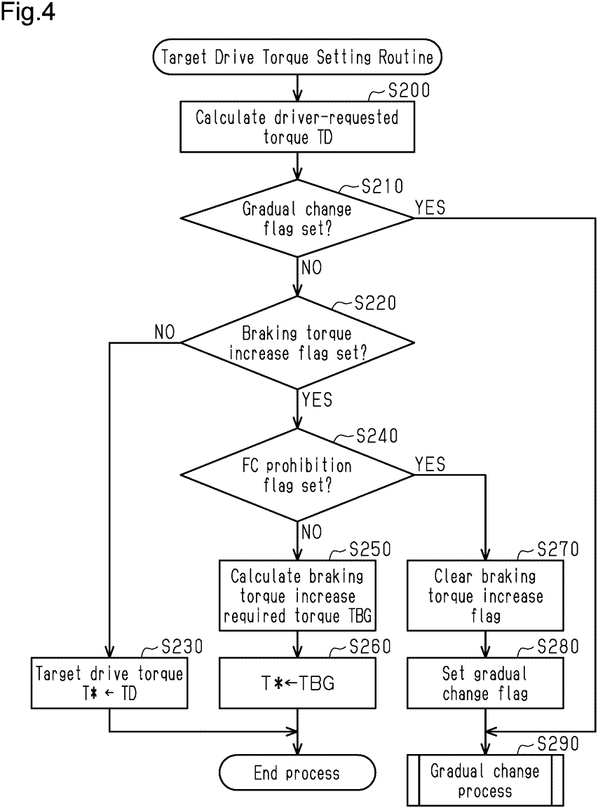

The electronic control unit 100 configured as described above performs travel control of the hybrid electric vehicle based on the input detection signals and information. In the travel control, the electronic control unit 100 sets the value of a target drive torque T* based on the accelerator pedal depression amount ACC, the vehicle speed V, and the like. The target drive torque T* represents a target value of the torque of the drive shaft 45 generated by the power unit. The electronic control unit 100 sets the value of the target drive torque T* in a target drive torque setting routine (FIG. 4), which will be discussed below.

The electronic control unit 100 performs torque control of the engine 10, the first motor generator 71, and the second motor generator 72 such that the torque of the drive shaft 45 generated by the power unit becomes equal to the target drive torque T*. At this time, the electronic control unit 100 determines the distribution of torque generated by each of the engine 10, the first motor generator 71, and the second motor generator 72 based on the efficiency of the engine 10 and the state of charge of the vehicle on-board battery 77.

The electronic control unit 100 may set, to a negative value, the value of the target drive torque T* during deceleration or the like of the hybrid electric vehicle. At this time, the electronic control unit 100 executes torque control of the engine 10, the first motor generator 71, and the second motor generator 72 so that the power unit generates braking torque on the drive shaft 45. Furthermore, depending on the situation, the electronic control unit 100 may execute a fuel cutoff process of the engine 10 to perform engine braking.

### Fuel Cutoff Process Prohibition Process

As described above, the engine 10 is provided with the filter device 23 that traps PM in the exhaust gas. When the fuel cutoff process is executed, the gas in the exhaust passage 21 is replaced with fresh air, so that a large amount of oxygen flows into the filter device 23. Then, the PM trapped in the filter device 23 is burned by the oxygen. Therefore, if the fuel cutoff process is executed in a state in which a large amount of PM is trapped, the temperature of the filter device 23 may rise beyond an allowable upper limit due to heat generated by combustion of the PM.

Therefore, the electronic control unit 100 estimates the amount of PM trapped by the filter device 23 based on the operating state of the engine 10. When the amount of trapped PM exceeds a specified threshold, the electronic control unit 100 prohibits execution of the fuel cutoff process. The electronic control unit 100 sets an FC prohibition flag to indicate that the fuel cutoff process is prohibited.

### Deceleration Assist Control

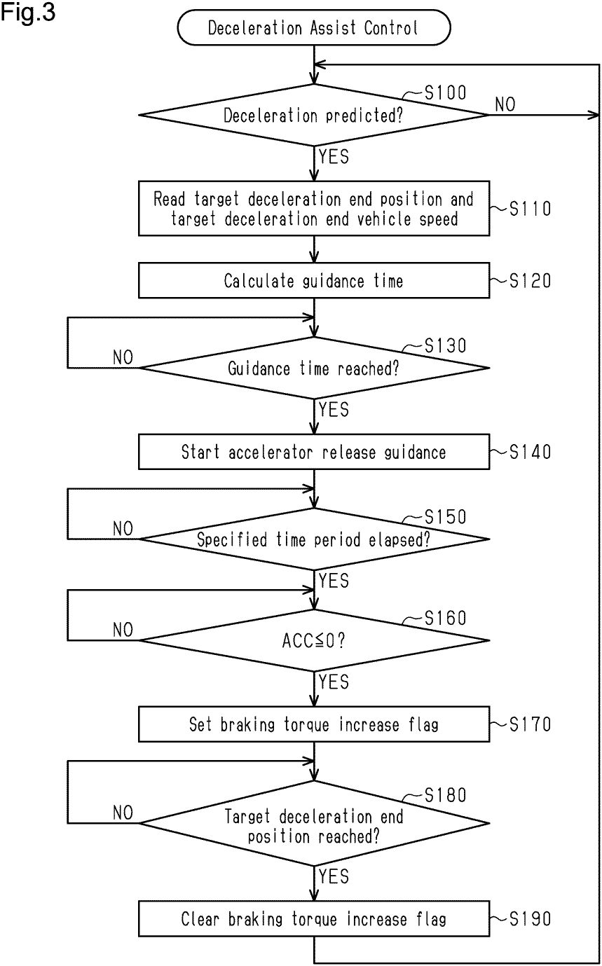

Next, a deceleration assist control executed by the electronic control unit 100 will be described with reference to FIG. 3. In the hybrid electric vehicle as described above, regenerative electricity generation is performed by the second motor generator 72 at the time of deceleration, whereby braking energy of the vehicle is converted into electricity and recovered. The electronic control unit 100 predicts whether deceleration will be performed during traveling of the hybrid electric vehicle. Then, the electronic control unit 100 executes the deceleration assist control for increasing the recovery efficiency of electricity at the time of deceleration on the basis of the prediction result of deceleration.

When the driver releases the brake pedal, that is, cancels the depressing force applied to the brake pedal, the electronic control unit 100 records the position of the vehicle at that time as a deceleration end position. Further, the electronic control unit 100 records the vehicle speed V when the vehicle reaches the deceleration end position as a deceleration end vehicle speed. Further, the electronic control unit 100 stores, as a target deceleration end position, a position recorded as the deceleration end position at a certain frequency or more. Further, the electronic control unit 100 stores, as a target deceleration end vehicle speed, an average value of the deceleration end vehicle speeds at the position stored as the target deceleration end position.

For example, the electronic control unit 100 predicts whether the vehicle will be decelerated based on various types of information such as the current position of the vehicle acquired from the navigation device 110 and the stored target deceleration end position.

FIG. 3 shows a flow of a process executed by the electronic control unit 100 for the deceleration assist control. In step S100 of FIG. 3, the electronic control unit 100 predicts whether deceleration will be performed. When it is predicted that deceleration will be performed (S100: YES), the electronic control unit 100 advances the process step S110.

In step S110, the electronic control unit 100 reads the stored target deceleration end position and the target deceleration end vehicle speed. Then, in step S120, the electronic control unit 100 calculates an accelerator-release guidance time, which is a time for guiding the driver to release the accelerator pedal. The electronic control unit 100 guides the driver to release the accelerator pedal by performing a guidance display on the display unit 111 to prompt the driver to release the accelerator pedal. Alternatively, the accelerator-release guidance may be performed by voice guidance or the like.

The electronic control unit 100 calculates the accelerator release guidance time in the following manner. The electronic control unit 100 calculates the deceleration start position where the electricity recovery efficiency during deceleration is high, and the vehicle speed V at the time of reaching the target deceleration end position becomes the target deceleration end vehicle speed. Then, the electronic control unit 100 calculates the time at which the vehicle is predicted to reach the deceleration start position after a specified time period TS as the accelerator release guidance time. The specified time period TS is set to a time period required for the driver to release the accelerator pedal in response to the guidance for the accelerator release.

When the calculated accelerator release guidance time is reached (S130: YES), the electronic control unit 100 starts the guidance for the accelerator release at step S140. Thereafter, when the specified time period TS has elapsed from the start of the guidance (S150: YES) and the accelerator pedal is released (S160: YES), the electronic control unit 100 sets a braking torque increase flag in step S170. When the hybrid electric vehicle reaches the target deceleration end position (S180: YES), the electronic control unit 100 clears the braking torque increase flag in step S190 and then returns the process to step S100. The electronic control unit 100 increases the braking torque of the hybrid electric vehicle during a period in which the braking torque increase flag is set in a drive torque control, which will be discussed below.

### Setting of Target Drive Torque

Next, referring to FIG. 4, a process of the electronic control unit 100 related to setting of the target drive torque T* will be described. While the hybrid electric vehicle is traveling, the electronic control unit 100 repeatedly executes the process of the target drive torque setting routine shown in FIG. 4 at specified control intervals.

When the target drive torque control routine is started, the electronic control unit 100 first calculates the driver-requested torque TD based on the accelerator pedal depression amount ACC and the vehicle speed V in step S200. The driver-requested torque TD represents a drive torque of the hybrid electric vehicle required to realize traveling requested by the driver through the operation of the accelerator pedal.

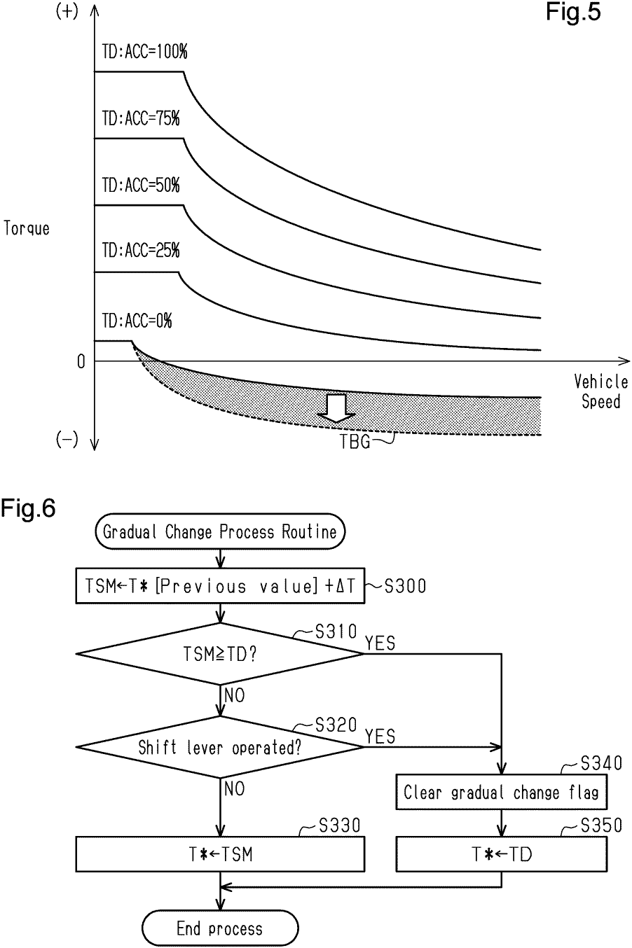

In FIG. 5, the relationships between the vehicle speed V and the driver-requested torque TD in the cases in which the accelerator pedal depression amount ACC is 0%, 25%, 50%, 75%, and 100% are indicated by solid lines. As shown in FIG. 5, when the accelerator pedal depression amount ACC is 0%, the value of the driver-requested torque TD is set to a negative value in a range in which the vehicle speed V is equal to or higher than a certain value.

Subsequently, in step S210, the electronic control unit 100 determines whether a gradual change flag is set. When the gradual change flag is not set (YES), the process proceeds to step S290. When the gradual change flag is not set (NO), the process proceeds to step S220. When the process proceeds to step S290, the electronic control unit 100 performs a gradual change process described later in step S290.

When the process proceeds to step S220, the electronic control unit 100 determines in step S220 whether the braking torque increase flag is set in the deceleration assist control described above. If the braking torque increase flag is not set (NO), the electronic control unit 100 sets the value of the target drive torque T* to the driver-requested torque TD in step S230, and ends the current process of this routine.

When the braking torque increase flag is set (S220: YES), the electronic control unit 100 determines in step S240 whether the FC prohibition flag is set, that is, whether the fuel cutoff process of the engine 10 is prohibited. If the FC prohibition flag is not set (NO), the electronic control unit 100 calculates a braking torque increase required torque TBG in step S250. Then, in step S260, the electronic control unit 100 sets the value of the target drive torque T* to the braking torque increase required torque TBG, and ends the current processing of this routine.

In FIG. 5, the relationship between the braking torque increase required torque TBG and the vehicle speed V is indicated by the dotted line. As shown in FIG. 5, the value of the braking torque increase required torque TBG is calculated to be smaller than the driver-requested torque TD when the accelerator pedal depression amount ACC is 0%.

If it is determined in step S240 of FIG. 4 that the FC prohibition flag is set (YES), the electronic control unit 100 clears the braking torque increase flag in step S270. Next, in step S280, the electronic control unit 100 sets the gradual change flag. Then, the electronic control unit 100 proceeds to step S290 to perform the gradual change process.

As described above, in the deceleration assist control, when the electronic control unit 100 predicts that the hybrid electric vehicle will decelerate, the electronic control unit 100 performs the accelerator release guidance. In the deceleration assist control, the electronic control unit 100 sets the braking torque increase flag at the time of deceleration of the vehicle according to the accelerator release guidance.

In the target drive torque setting routine, the electronic control unit 100 basically sets the value of the target drive torque T* to the driver-requested torque TD when the braking torque increase flag is cleared, and sets value of the target drive torque T* to the braking torque increase request torque TBG when the braking torque increase flag is set. As described above, the braking torque increase required torque TBG is set to a value that is smaller than the driver-requested torque TD when the accelerator pedal depression amount ACC is 0%, that is, a value that increases the braking torque. Therefore, in the deceleration assist control, when the vehicle is predicted to decelerate, the electronic control unit 100 increases the braking torque generated by the power unit at the time of vehicle deceleration as compared with the case in which the vehicle is not predicted to decelerate.

In the present embodiment, even when the braking torque increase flag is set, the electronic control unit 100 clears the braking torque increase flag when the FC prohibition flag is set, that is, when the fuel cutoff process of the engine 10 is prohibited. That is, in the present embodiment, when the fuel cutoff process of the engine 10 is prohibited, the increase of the braking torque in the deceleration assist control is prohibited. In the present embodiment, the process in steps S240 and S270 in FIG. 4 corresponds to the braking torque increase prohibiting process.

Further, in the target drive torque setting routine, the electronic control unit 100 sets the gradual change flag when the FC prohibition flag is set in a state in which the braking torque increase flag is set. When the gradual change flag is set, the electronic control unit 100 performs the gradual change process.

### Gradual Change Process

Next, referring to FIG. 6, the gradual change process will be described, which is performed by the electronic control unit 100 when the process proceeds to step S290 in FIG. 4. FIG. 6 shows a flowchart of a gradual change process routine executed by the electronic control unit 100 during the gradual change process.

When starting the gradual change process routine, the electronic control unit 100 first calculates the sum of a previous value of the target drive torque T* and a specified gradual change constant ΔT as the value of a gradual change target torque TSM in step S300. The previous value of the target drive torque T* represents the calculated value of the target drive torque T* in the previous control cycle.

When both of the following conditions (A) and (B) are not satisfied (S310: NO, and S320: NO), the process proceeds to step S330. When the process proceeds to step S330, the electronic control unit 100 sets the value of the target drive torque T* to the value of the gradually changing target torque TSM in step S330, and then ends the process of this routine in the current control cycle. The condition (A) is that the gradual change target torque TSM is equal to or larger than the driver-requested torque TD (S310: YES). The satisfaction of the condition (A) indicates that the increase amount of the braking torque by the deceleration assist control has decreased to 0 through the gradual change process. The condition (B) is that the driver has operated the shift lever.

When at least one of the conditions (A) and (B) is satisfied, the process proceeds to step S340. Then, the electronic control unit 100 clears the gradual change flag at step S340. Then, in step S350, the electronic control unit 100 sets the value of the target drive torque T* to the driver-requested torque TD, and then ends the current process of this routine. At this time, since the gradual change flag is cleared, the gradual change process is not performed in the next control cycle. That is, the gradual change process is ended.

### Operation and Advantages of Embodiment

Next, operation of the vehicle controller according to the present embodiment will be described.

When the driver applies a sudden brake immediately before the deceleration end position to decelerate the vehicle, the amount of electricity that can be recovered by regenerative braking is smaller than when the vehicle is decelerated by regenerative braking from a position sufficiently before the deceleration end position. In this case, the electronic control unit 100 executes the following deceleration assist control. When predicting that the vehicle will decelerate in the deceleration assist control, the electronic control unit 100 guides the driver to release the accelerator pedal. When the driver releases the accelerator pedal in response to the guidance and the vehicle shifts to a deceleration state, the electronic control unit 100 increases the braking torque generated by the power unit to be larger than that at the time of normal deceleration. With the above-described guidance, deceleration of the vehicle is more likely to be performed by regenerative braking rather than sudden braking. In addition, the amount of regenerative electricity generation during deceleration of the vehicle increases due to an increase in the braking torque. Therefore, the electricity that can be recovered at the time of vehicle deceleration increases.

When the PM trapped amount of the filter device 23 exceeds a certain amount, the electronic control unit 100 prohibits the fuel cutoff process of the engine 10 in order to prevent overheating of the filter device 23. When the fuel cutoff process is prohibited, the braking torque that can be generated by the engine 10, i.e., the braking torque by the so-called engine braking decreases. Therefore, when the fuel cutoff process is prohibited, the regenerative torque of the first motor generator 71 and the second motor generator 72 required for ensuring the braking torque increased by the deceleration assist control is larger than that when the fuel cutoff process is not prohibited. There is an upper limit to the amount of charge per hour of the vehicle on-board battery 77. Therefore, if the braking torque is increased by the deceleration assist control in a state in which the fuel cutoff process is prohibited, excessive regeneration may be performed and overcharge of the vehicle on-board battery 77 may occur.

In the hybrid electric vehicle, the engine 10, the first motor generator 71, and the drive shaft 45 are coupled to each other via the first planetary gear mechanism 40. In such a hybrid electric vehicle, when the rotation speed of the drive shaft 45 is decreased while the rotation speed of the engine 10 is maintained, the rotation speed of the first motor generator 71 is increased. On the other hand, when the braking torque is increased by the deceleration assist control, the rotation speed of the drive shaft 45 during the vehicle deceleration decreases more rapidly than usual. At this time, if the fuel cutoff process is performed, the rotation speed of the engine 10 rapidly decreases, and thus the increase in the rotation speed of the first motor generator 71 is suppressed within an allowable range. However, when the fuel cutoff process is prohibited, the decrease in the rotation speed of the engine 10 becomes slow, and the rotation speed of the first motor generator 71 may increase beyond an allowable limit.

When the fuel cutoff process is prohibited, the electronic control unit 100 prohibits the increase of the braking torque in the deceleration assist control. Therefore, the overcharge of the vehicle on-board battery 77 and the overspeed of the first motor generator 71 as described above are unlikely to occur.

The increase of the braking torque may be prohibited by prohibiting the fuel cutoff process while the braking torque is increasing by the deceleration assist control. If the increase of the braking torque by the deceleration assist control is stopped immediately after the fuel cutoff process is prohibited, the braking torque may rapidly decrease and the occupant may feel uncomfortable. In this regard, when the fuel cutoff process is prohibited while the braking torque is increasing by the deceleration assist control, the electronic control unit 100 performs the gradual change processing. In the gradual change process, the electronic control unit 100 increases the target drive torque T* by a specified gradual change constant ΔT in each control cycle. That is, in the gradual change process, the electronic control unit 100 gradually brings the increase amount of the braking torque close to 0 when the fuel cutoff process is prohibited while the braking torque is being increased by the deceleration assist control. Therefore, a rapid decrease in braking torque is prevented.

The electronic control unit 100 ends the gradual change process when the gradual change target torque TSM reaches the driver-requested torque TD, that is, when the increase amount of the braking torque by the deceleration assist control becomes 0. The electronic control unit 100 also terminates the gradual change process when the driver performs a shift lever operation during the gradual change process. The shift lever operation by the driver is performed for the purpose of changing the drive torque. Therefore, even if the braking torque is suddenly changed after the shift lever operation, the occupant is unlikely to feel discomfort. Therefore, when the shift lever operation is performed, the electronic control unit 100 ends the gradual change process so that the traveling requested by the driver is quickly realized.

The vehicle controller of the present embodiment achieves the following advantages.

(1) When it is predicted that the vehicle will decelerate, the vehicle controller according to the present embodiment performs the deceleration assist control to increase the braking torque generated by the power unit during deceleration of the vehicle as compared with a case in which such prediction is not made. When the fuel cutoff process of the engine 10 is prohibited, the vehicle controller performs the deceleration assist prohibition process for prohibiting increase of braking torque in the deceleration assist control. Therefore, the braking torque is not increased by the deceleration assist control in a state in which the fuel cutoff process is prohibited. Therefore, overcharging of the vehicle on-board battery 77 due to excessive regenerative braking is unlikely to occur.

(2) The vehicle controller of the present embodiment prohibits the fuel cutoff process of the engine 10 when the PM trapped amount of the filter device 23 installed in the engine 10 exceeds the specified threshold. Therefore, overheating of the filter device 23 due to combustion of the PM trapped in the filter device 23 by the fuel cutoff process is avoided.

(3) In a state in which the rotation speed of the engine 10 is unlikely to decrease due to the prohibition of the fuel cutoff process, the braking torque is not increased by the deceleration assist control. Therefore, overspeed of the first motor generator 71 is unlikely to occur.

(4) When the fuel cutoff process is prohibited while the braking torque is being increased by the deceleration assist control, the vehicle controller according to the present embodiment performs the gradual change process for gradually bringing the increase amount of the braking torque by the deceleration assist control close to 0. Therefore, it is possible to suppress deterioration of drivability due to a sudden decrease in braking torque.

(5) While the gradual change process is being performed, the drive torque generated by the power unit does not agree with the driver’s request. To cope with this, the vehicle controller according to the present embodiment ends the gradual change process at a time point when the increase amount of the braking torque by the deceleration assist control decreases to 0 or at a time point when the shift lever operation is performed. Therefore, it is possible to prevent a state in which the drive torque generated by the power unit deviates from the driver’s request from continuing for an unnecessarily long time.

### Other Embodiments

The above-described embodiment can be modified as follows. The above-described embodiment and the following modifications can be implemented in combination with each other as long as there is no technical contradiction.

In the above-described embodiment, when the PM trapped amount of the filter device 23 exceeds the threshold, the fuel cutoff process of the engine 10 is prohibited. For example, if the fuel cutoff process is performed in a state in which the deterioration of the three-way catalyst device 22 has progressed, the deterioration of the three-way catalyst device 22 may be accelerated. Therefore, the fuel cutoff process may be prohibited when the deterioration degree of the three-way catalyst device 22 exceeds a threshold.

The condition for ending the gradual change process in the above embodiment may be changed. For example, the gradual change process may also be terminated when the driver depresses the accelerator pedal. Even when the fuel cutoff process is prohibited while the braking torque is increasing by the deceleration assist control, the driver-requested torque TD may be immediately set to the target drive torque T* without performing the gradual change process.

The second motor generator 72 is configured as a generator motor having both a function as a motor and a function as a generator. Instead of the second motor generator 72, a device dedicated to regenerative electricity generation may be employed. That is, any device may be used as long as it has a function as a regenerative braking device that generates electricity by the force transmitted from the wheel 62.

The vehicle controller of the above-described embodiment may be applied to a hybrid electric vehicle having a configuration different from that of FIG. 1. For example, the vehicle controller of the above-described embodiment may be applied to a hybrid electric vehicle having a configuration in which an engine, a regenerative braking device, and wheels are connected in series.

The electronic control unit 100 is not limited to a device that includes the processor 101 and the memory device 102. For example, the electronic control unit 100 may include a dedicated hardware circuit (for example, an application-specific integrated circuit (ASIC)) that executes at least part of the processes executed in the above-described embodiment. That is, the electronic control unit 100 may be processing circuitry that includes any one of the following configurations (a) to (c).

(a) Processing circuitry including at least one processor that executes all of the above-described processes according to programs and at least one program storage device such as a ROM that stores the programs.

(b) Processing circuitry including at least one processor and at least one program storage device that execute part of the above-described processes according to the programs and at least one dedicated hardware circuit that executes the remaining processes.

(c) Processing circuitry including at least dedicated hardware circuit that executes all of the above-described processes.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A controller for a vehicle, wherein
the vehicle includes a power unit coupled to wheels,
the power unit includes:
an engine configured to generate force by combustion of a fuel; and
a regenerative braking device configured to generate electricity by force transmitted from the wheels,
the controller includes processing circuitry,
the processing circuitry is configured to execute:
a deceleration assist control that increases a braking torque generated by the power unit during a deceleration of the vehicle when the vehicle is predicted to decelerate, compared to when the vehicle is not predicted to decelerate; and
a braking torque increase prohibition process that prohibits an increase in the braking torque in the deceleration assist control when a fuel cutoff process of the engine is prohibited.

2. The controller for the vehicle according to claim 1, wherein
the engine includes a filter device configured to trap particulate matter in exhaust gas, and
the processing circuitry is configured to prohibit the fuel cutoff process when a trapped amount of the particulate matter in the filter device exceeds a specified threshold.

3. The controller for the vehicle according to claim 1, wherein the processing circuitry is configured to execute a gradual change process that gradually brings an increase amount of the braking torque by the deceleration assist control close to 0 when the fuel cutoff process is prohibited while the braking torque is being increased by the deceleration assist control.

4. The controller for the vehicle according to claim 3, wherein the processing circuitry is configured to end the gradual change process when the increase amount of the braking torque by the deceleration assist control decreases to 0.

5. The controller for the vehicle according to claim 3, wherein the processing circuitry is configured to end the gradual change process when a shift lever is operated by a driver.

6. A control method for a vehicle, wherein
the vehicle includes a power unit coupled to wheels,
the power unit includes:
an engine configured to generate force by combustion of a fuel; and
a regenerative braking device configured to generate electricity by force transmitted from the wheels
the method comprises:
predicting whether the vehicle will decelerate;
executing a deceleration assist control that increases a braking torque generated by the power unit during a deceleration of the vehicle when the vehicle is predicted to decelerate, compared to when the vehicle is not predicted to decelerate;
determining whether to prohibit a fuel cutoff process of the engine; and
when the fuel cutoff process is prohibited, prohibiting an increase in the braking torque in the deceleration assist control.
